(19) United States
(12) Patent Application Publication
(10) Pub. No.: US 2024/0320053 A1
(43) Pub. Date: Sep. 26, 2024

(54) ELECTRONIC DEVICE AND DEVICE RESOURCE MANAGEMENT METHOD THEREOF

(71) Applicant: SigmaStar Technology Ltd., Xiamen (CN)

(72) Inventor: Hong Yang, Shenzhen (CN)

(21) Appl. No.: 18/389,842

(22) Filed: Dec. 20, 2023

(30) Foreign Application Priority Data
Mar. 22, 2023 (CN) 202310286815.X

(51) Int. Cl. G06F 9/50

(52) U.S. Cl. CPC G06F 9/5055; G06F 9/5044

(57) ABSTRACT

An electronic device executes multiple applications and includes a memory storing a first and second lists. The first and second lists respectively contain at least one piece of application resource information and at least one device driver which corresponds to the at least one piece of application resource information. Each device driver corresponds to at least one piece of device resource information. A device resource management method includes steps of: in response to an abnormal exit procedure of a target application of the applications, searching the first list for a piece of target application resource information that corresponds to the target application and is one of the at least one piece of application resource information; determining a target device driver according to the piece of target application resource information; and deleting a piece of target device resource information corresponding to the target device driver from the second list.

This application claims the benefit of China application Serial No. 202310286815.X, filed on Mar. 22, 2023, the subject matter of which is incorporated herein by reference.

### BACKGROUND OF THE INVENTION

### 1. Field of the Invention

The present invention generally relates to an electronic device, and, more particularly, to an electronic device and a device resource management method thereof.

### 2. Description of Related Art

As user applications are developed bigger and bigger, there are more and more modules, and the use of multi-process application scenarios is also increasing. Device drivers in the past have limited support for multi-process application scenarios and cannot meet the needs of most embedded electronic products. One application corresponds to one process. For example, in a vehicle dashboard recorder, the main application is responsible for the complete image display and recording function, one application is responsible for the graphical user interface (GUI) operation function, while another application is responsible for the driving road blind spot detection (BSD) function.

When a subprocess exits abnormally, the kernel of the Linux platform closes different device driver nodes to free resources, and finally the “deinit” call back function of each device driver takes over to execute different recycling processes. However, this method cannot ensure that the operation of other processes is not affected. Furthermore, all of the resources of the device driver module are freed only when the main process finally exits, wasting memory and reducing system performance.

### SUMMARY OF THE INVENTION

In view of the issues of the prior art, an object of the present invention is to provide an electronic device and a device resource management method thereof, so as to make an improvement to the prior art.

According to one aspect of the present invention, a device resource management method of an electronic device is provided. The electronic device includes a memory and executes multiple applications. The memory stores a first list and a second list. The first list includes at least one piece of application resource information, and the second list includes at least one device driver. The at least one piece of application resource information corresponds to the at least one device driver. Each device driver corresponds to at least one piece of device resource information. The device resource management method includes the following steps: searching the first list for a piece of target application resource information corresponding to a target application of the applications in response to an abnormal exit procedure of the target application, wherein the piece of target application resource information is one of the at least one piece of application resource information; determining a target device driver according to the piece of target application resource information; and deleting a piece of target device resource information corresponding to the target device driver from the second list.

According to another aspect of the present invention, an electronic device is provided. The electronic device executes multiple applications and includes a memory, an application circuit, and a processing circuit. The memory is configured to store a first list and a second list. The first list includes at least one piece of application resource information, and the second list includes at least one device driver. The at least one piece of application resource information corresponds to the at least one device driver. Each device driver corresponds to at least one piece of device resource information. The processing circuit is coupled to the memory and the application circuit and configured to perform the following steps: executing a target application corresponding to the application circuit, wherein the target application is one of the applications; searching the first list for a piece of target application resource information corresponding to the target application in response to an abnormal exit procedure of the target application, wherein the piece of target application resource information is one of the at least one piece of application resource information; determining a target device driver according to the piece of target application resource information; and deleting a piece of target device resource information corresponding to the target device driver from the second list.

According to still another aspect of the present invention, an electronic device is provided. The electronic device executes multiple applications and includes a memory, an application circuit, and a processing circuit. The memory is configured to store a first list and a second list. The first list includes at least one piece of application resource information, and the second list includes at least one device driver. The at least one piece of application resource information corresponds to the at least one device driver. Each device driver corresponds to at least one piece of device resource information. The processing circuit is coupled to the memory and the application circuit and configured to perform the following steps: executing a target application corresponding to the application circuit, wherein the target application is one of the applications; creating a piece of target application resource information of the target application in the first list; searching for a target device driver associated with the target application according to the piece of target application resource information; and creating a piece of target device resource information when the target device driver does not include the piece of target device resource information. The piece of target device resource information corresponds to the target device driver and is recorded in a device resource information list used by the target device driver.

The technical means embodied in the embodiments of the present invention can solve at least one of the problems of the prior art. Therefore, compared to the prior art, the present invention can avoid wasting memory waste and reducing system performance.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 is a functional block diagram of an electronic device according to an embodiment of the present invention.

FIG. 2 shows a schematic diagram of the process resource management list LST_AP and the device resource management list LST_DD in FIG. 1 according to an embodiment.

FIG. 3 shows the content of a piece of device resource information.

FIG. 4 is a schematic diagram of an operating system architecture according to an embodiment of the present invention.

FIG. 5 is a flowchart of an add application resource information function according to an embodiment of the present invention.

FIG. 6 is a flowchart of a delete application resource information function according to an embodiment of the present invention.

FIG. 7 is a flowchart of a free device resource function according to an embodiment of the present invention.

FIG. 8 is a flowchart of a device resource management method according to an embodiment of the present invention.

FIG. 9 is a detailed flow of opening an application according to the present invention.

FIG. 10 is a flowchart of a normal exit procedure of an application according to an embodiment of the present invention.

FIG. 11 is a flowchart of an abnormal exit procedure of an application according to an embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes an electronic device and a device resource management method. On account of that some or all elements of the electronic device could be known, the detail of such elements is omitted provided that such detail has little to do with the features of this disclosure, and that this omission nowhere dissatisfies the specification and enablement requirements. Some or all of the device resource management method may be implemented by software and/or firmware and can be performed by the electronic device or its equivalent. A person having ordinary skill in the art can choose components or steps equivalent to those described in this specification to carry out the present invention, which means that the scope of this invention is not limited to the embodiments in the specification.

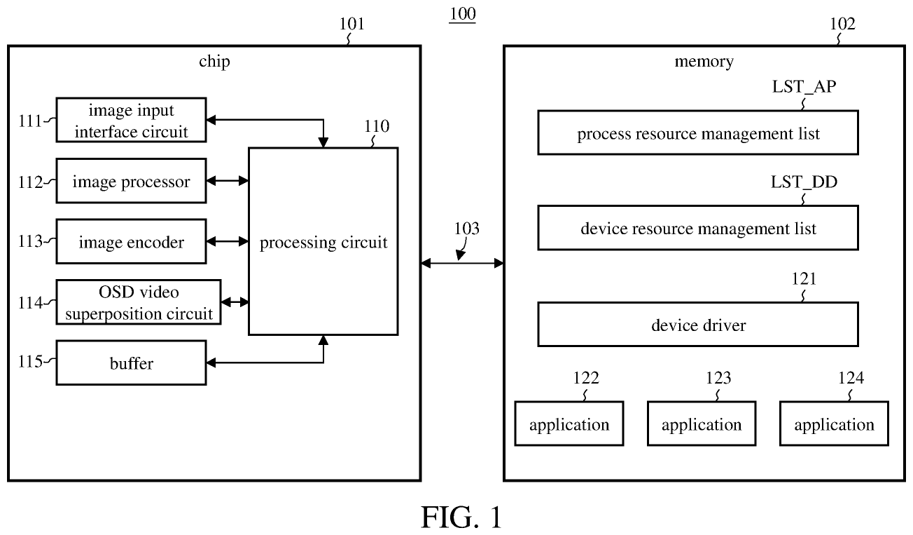

Reference is made to FIG. 1 which is a functional block diagram of an electronic device according to an embodiment of the present invention. The electronic device 100 includes a chip 101 and a memory 102. The chip 101 includes a processing circuit 110 and multiple application circuits (including but not limited to an image input interface circuit 111, an image processor 112, an image encoder 113, an on screen display (OSD) video superposition circuit 114, and a buffer 115). The memory 102 stores the process resource management list LST_AP, the device resource management list LST_DD, the device driver 121, and multiple applications (including but not limited to an application 122, an application 123, and an application 124). The processing circuit 110 accesses the memory 102 through the memory interface or bus 103.

The processing circuit 110 may be a circuit or an electronic component capable of executing programs, such as a central processing unit (CPU), a microprocessor, a micro-processing unit, a digital signal processor (DSP), an application specific integrated circuit (ASIC), or their equivalents. The processing circuit 110 executes applications and the operating system of the electronic device 100 by executing the program codes and/or program instructions stored in the memory 102.

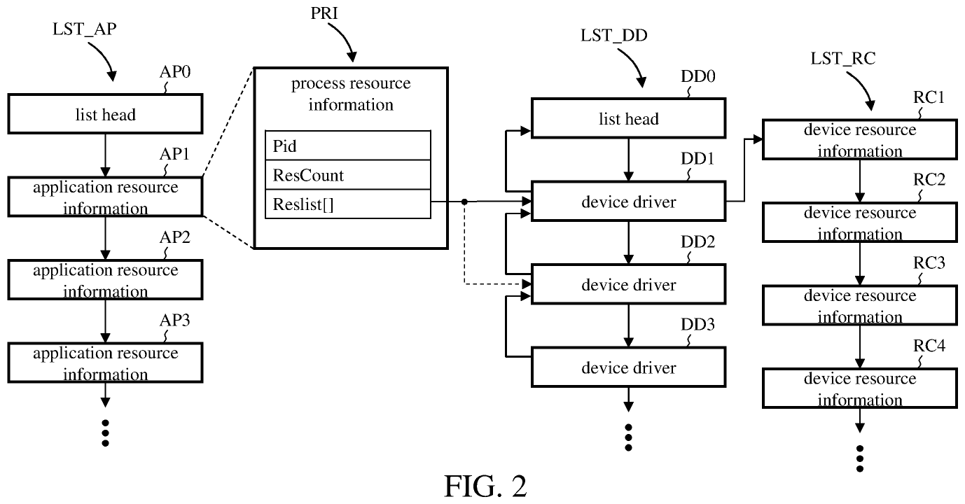

Reference is made to FIG. 2 which shows a schematic diagram of the process resource management list LST_AP and the device resource management list LST_DD in FIG. 1 according to an embodiment. The process resource management list LST_AP includes a list head AP0 and multiple pieces of application resource information (including a piece of application resource information AP1, a piece of application resource information AP2, a piece of application resource information AP3, . . . ). Each piece of application resource information corresponds to an application and includes a piece of process resource information PRI. The piece of process resource information PRI contains an application identification (ID) Pid, a total number of device resource(s) ResCount, and a device driver resource list Reslist[ ].

The device resource management list LST_DD includes a list head DD0 and multiple device drivers (including a device driver DD1, a device driver DD2, a device driver DD3, . . . ). Each device driver contains or corresponds to a device resource information list LST_RC. The device resource information list LST_RC includes one piece of device resource information or more (including a piece of device resource information RC1, a piece of device resource information RC2, a piece of device resource information RC3, a piece of device resource information RC4, . . . ).

The device driver resource list Reslist[ ] of the piece of process resource information PRI corresponds to N device drivers, and N is associated with the complexity of the application corresponding to the piece of application resource information. For example, when the application corresponding to the piece of application resource information AP1 is more complex (i.e., the application requires more device resources), the device driver resource list Reslist[ ] of the piece of application resource information AP1 may correspond to the device driver DD1, the device driver DD2, or more device drivers. When the application corresponding to the piece of application resource information AP1 is less complex (i.e., the application requires fewer device resources), the device driver resource list Reslist[ ] of the piece of application resource information AP1 may correspond to only the device driver DD1.

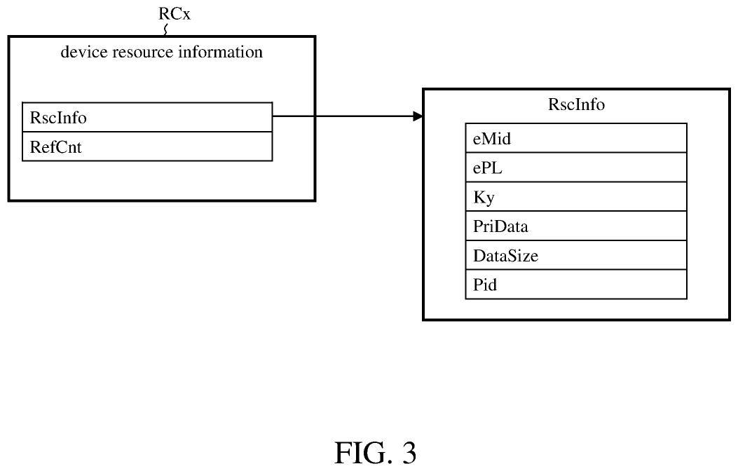

Reference is made to FIG. 3 which shows the content of the piece of device resource information. The piece of device resource information RCx (x=1, 2, 3, . . . ) includes the device resource data RscInfo and the device resource usage count RefCnt. The device resource data RscInfo records information about a device resource used by the corresponding device driver, such as the module ID eMid, the level ePL, the key Ky, the private data PriData, the data size DataSize, and the application ID Pid.

The module ID eMid records the driver type of the device resource.

The level ePL is the level of the device resource and determines the order in which the resources are freed. For example, when the device resource is initialized, the level ePL is 0; when a device is created or handled, the level ePL is one; when a channel is created, the level ePL is two.

The key Ky is the unique identification of the resource of the same level as the device resource in the current application. For example, if the key Ky is 64 bits, the upper 32 bits represent the type of the current resource, and the lower 32 bits represent the type of the created resource. Channels of the same device resource are subdivided into upper 16 bits and lower 16 bits of the resource type value.

The application ID Pid represents the application ID Pid of the application using the piece of device resource information.

The private data PriData records the additional private data needed to free the piece of device resource information. The data size DataSize records the size of the private data PriData. The default value of the private data PriData is NULL, and the default value of the data size DataSize is zero.

Reference is made to both FIG. 1 and FIG. 2 at the same time. An application circuit may correspond to an application. More specifically, the processing circuit 110 executes the application corresponding to an application circuit to operate or manage that application circuit. For example, the processing circuit 110 executes an application of the OSD video superposition circuit 114 (e.g., the application 122) to operate or manage the OSD video superposition circuit 114. An application being executed by the processing circuit 110 is recorded in the process resource management list LST_AP (i.e., as a node of the process resource management list LST_AP). One or more device drivers used by that application are recorded in the device resource management list LST_DD (i.e., as one or more nodes of the device resource management list LST_DD). The piece of device resource information associated with a certain device driver (i.e., the device resource that the device driver uses (e.g., the input/output device of the electronic device 100, the buffer 115, etc.)) is recorded in the device resource information list LST_RC of the device driver.

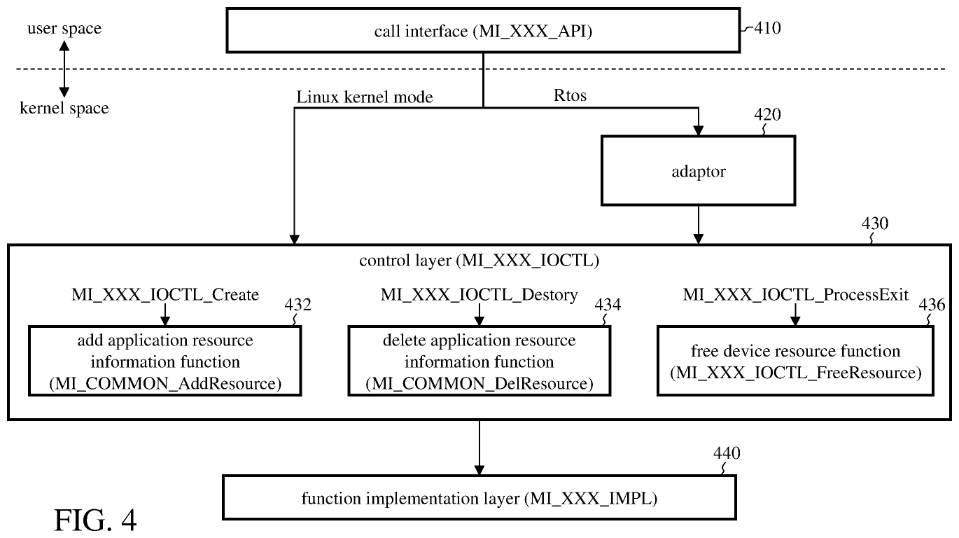

Reference is made to FIG. 4 which is a schematic diagram of an operating system architecture according to an embodiment of the present invention.

The call interface 410 (MI_XXX_API) is a call interface provided by the device driver to the user space and may include functions associated with the device driver, such as create, initialize, stop, destroy, set and get, etc. The “XXX” in “MI_XXX_API” stands for various function names, and other names discussed below also apply.

The control layer 430 (MI_XXX_IOCTL) is the control layer of the device driver from the user space to the kernel space. For the Linux platform, the control layer is entered through a kernel system call. For the dualos platform, it is necessary to switch from the user space to the Real-time operating system (Rtos) system space through the adaptor 420 first. The kernel system call and the adaptor 420 are well known to people having ordinary skill in the art, so the details are omitted for brevity.

The function implementation layer 440 (MI_XXX_IMPL) is the device driver function implementation layer and configured to communicate with the device hardware to complete corresponding functions.

The present invention implements the following three functions in the control layer 430: the add application resource information function 432 (MI_COMMON_AddResource), the delete application resource information function 434 (MI_COMMON_De1Resource), and the free device resource function 436 (MI_XXX_IOCTL_FreeResource).

In some embodiments, the user can call the creation function “MI_XXX_IOCTL_Create” of the control layer 430 by calling the creation function “MI_XXX_Create” of the call interface 410 to activate the add application resource information function 432.

In some embodiments, the user can call the destroy function “MI_XXX_IOCTL_Destory” of the control layer 430 by calling the destroy function “MI_XXX_Destroy” of the call interface 410 to activate the delete application resource information function 434.

In some embodiments, when an application exits due to triggering a system exception, the system exception (e.g., “kill-9”) is called, triggering the “MI_XXX_IOCTL_ProcessExit” function of the control layer 430, which in turn triggers the free device resource function 436.

Implementing the above three functions in the control layer 430 has the following advantages: (1) The process resource records of the user applications and the device drivers are separated, so the user does not need to worry about the implementation details, but simply follows the original user interface of the device drivers to implement the functions of each application; and (2) the differences between different operating system platforms are taken into account, so that the multi-processing function of the device driver can be supported on both Linux-only and dualos (Linux and Rtos) platforms.

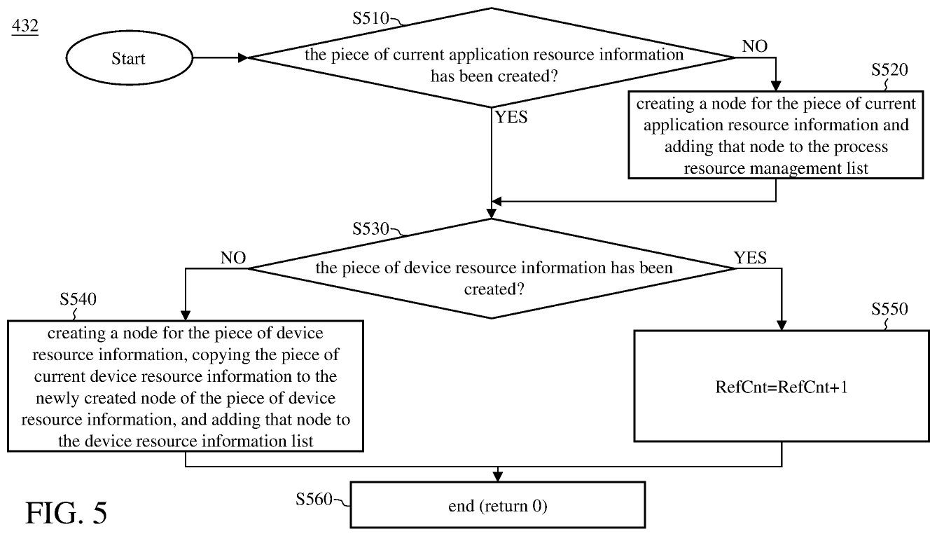

The three functions are discussed below with reference to FIGS. 5-7.

Reference is made to FIG. 5 which is a flowchart of the add application resource information function according to an embodiment of the present invention. The add application resource information function 432 is used to add a piece of application resource information (i.e., add a node) in the process resource management list LST_AP and change some related parameters when an application is initialized. The add application resource information function 432 includes the following steps.

Step S510: The processing circuit 110 determines whether the piece of application resource information corresponding to the current application has been created. More specifically, because an application corresponds to an application ID Pid, in this step, the processing circuit 110 uses the application ID Pid of the current application to search the process resource management list LST_AP for the piece of application resource information corresponding to the current application. If found (i.e., the piece of application resource information corresponding to the current application has been created), the processing circuit 110 performs step S530; otherwise, the processing circuit 110 performs step S520.

Step S520: The processing circuit 110 creates a node for the piece of current application resource information, and adds that node to the process resource management list LST_AP. The application ID Pid of the piece of process resource information PRI is the application ID Pid of the current application; the device driver resource list Reslist[ ] of the piece of process resource information PRI points to one or more device drivers associated with the current application; the value of the total number of device resource(s) ResCount is the total number of device resource(s) used by the associated device driver(s).

Step S530: The processing circuit 110 determines whether the piece of device resource information of the device resource used by the associated device driver has been created. More specifically, the processing circuit 110 searches the device resource information list LST_RC for the piece of device resource information by at least one of the module ID eMid, the level ePL, and the key Ky. If not found (i.e., the piece of device resource information of the device resource used by the associated device driver has not been created), the processing circuit 110 performs step S540; otherwise, the processing circuit 110 performs step S550.

Step S540: The processing circuit 110 creates a node for the piece of device resource information, copies the piece of current device resource information to the newly created node of the piece of device resource information, and adds that node to the device resource information list LST_RC. If the private data PriData of the piece of current device resource information is not empty, the processing circuit 110 further copies the private data PriData to that piece of newly created device resource information. In addition, the processing circuit 110 further adds one to the device resource usage count RefCnt of that piece of newly created device resource information and adds one to the total number of device resource(s) ResCount of the current application.

Step S550: The processing circuit 110 changes (e.g., increases by one) the device resource usage count RefCnt of the piece of device resource information. Because the device resource corresponding to the piece of device resource information is used by the current application, the processing circuit 110 adds one to the device resource usage count RefCnt of that piece of device resource information.

Step S560: The add application resource information function 432 ends normally (a first return value (e.g., 0) is returned).

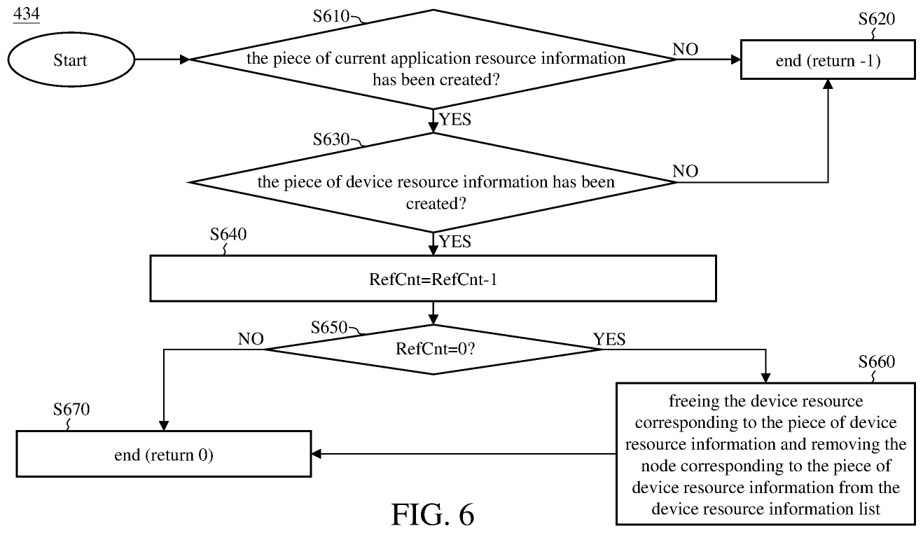

Reference is made to FIG. 6 which is a flowchart of the delete application resource information function according to an embodiment of the present invention. The delete application resource information function 434 is used to delete a piece of application resource information (i.e., delete a node) from the process resource management list LST_AP when the application exits normally. The delete application resource information function 434 includes the following steps.

Step S610: The processing circuit 110 determines whether the piece of application resource information corresponding to the current application has been created. Step S610 is the same as step S510, so the details are omitted for brevity. If the piece of application resource information corresponding to the current application has not been created (i.e., the result of step S610 is NO), the processing circuit 110 performs step S620; otherwise, the processing circuit 110 performs step S630.

Step S620: The delete application resource information function 434 ends abnormally (a second return value (e.g., −1) is returned).

Step S630: The processing circuit 110 determines whether the piece of device resource information of the device resource used by one or more device drivers associated with the current application has been created. Step S630 is the same as step S530, and the details are omitted for brevity. If the piece of device resource information of the device resource has been created (i.e., the result of step S630 is YES), the processing circuit 110 performs step S640; otherwise, the processing circuit 110 performs step S620.

Step S640: The processing circuit 110 changes (e.g., reduces by one) the device resource usage count RefCnt of the piece of device resource information of the device resource. Since the current application will not use the associated device resource after exited, the processing circuit 110 decrements the device resource usage count RefCnt of the associated device resource by one.

Step S650: The processing circuit 110 determines whether the device resource usage count RefCnt of the piece of device resource information is a default value (e.g., zero). If YES (meaning that the device resource corresponding to that piece of device resource information is no longer used by any application), the processing circuit 110 performs step S660; otherwise, the processing circuit 110 performs step S670.

Step S660: The processing circuit 110 frees the device resource corresponding to the piece of device resource information and removes the node corresponding to the piece of device resource information from the device resource information list LST_RC. If the private data PriData of the piece of device resource information is not empty, the processing circuit 110 further frees the memory corresponding to the private data PriData.

Step S670: The delete application resource information function 434 ends normally (the first return value (e.g., 0) is returned).

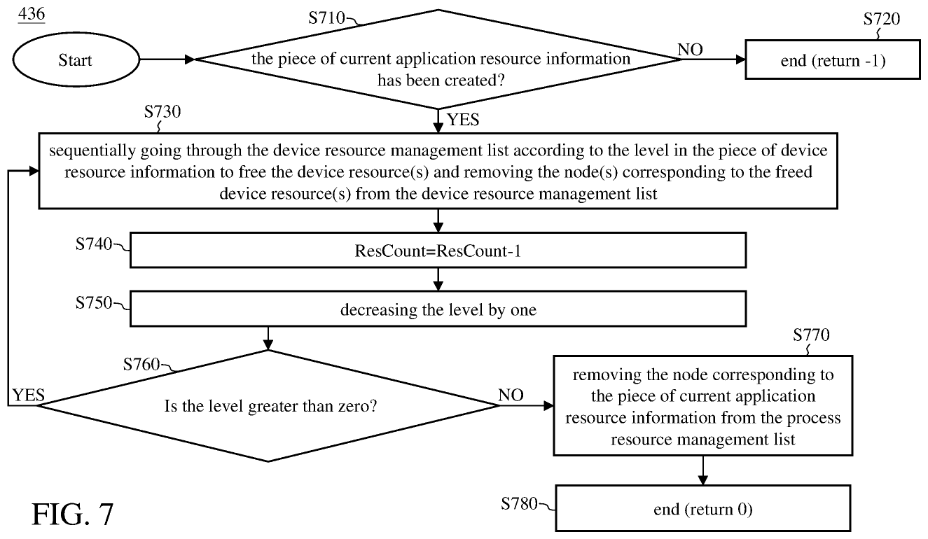

Reference is made to FIG. 7 which is a flowchart of the free device resource function according to an embodiment of the present invention. The free device resource function 436 is used to free device resource(s) when the application exits abnormally. The free device resource function 436 includes the following steps.

Step S710: The processing circuit 110 determines whether the piece of application resource information corresponding to the current application has been created. Step S710 is the same as step S510, and the details are omitted for brevity. If the piece of application resource information corresponding to the current application has not been created (i.e., the result of step S710 is NO), the processing circuit 110 performs step S720; otherwise, the processing circuit 110 performs step S730.

Step S720: The free device resource function 436 ends abnormally (the second return value (e.g., −1) is returned).

Step S730: The processing circuit 110 sequentially goes through the device resource management list LST_DD according to the level ePL in the piece of device resource information to free the device resource(s), and removes the node(s) corresponding to the freed device resource(s) from the device resource management list LST_DD. More specifically, the processing circuit 110 first frees the device resource(s) corresponding to the piece(s) of device resource information whose level ePL is higher, and then frees the piece(s) of device resource(s) corresponding to the piece(s) of device resource information whose level ePL is lower. The processing circuit 110 frees a device resource according to its private data PriData.

Step S740: Since a device resource of the current application has been freed, the processing circuit 110 decreases the total number of device resource(s) ResCount of the current application by one.

Step S750: The processing circuit 110 decreases the level ePL by one.

Step S760: The processing circuit 110 determines whether the level ePL is greater than zero. If YES (meaning that there may still be device resource(s) to be freed), the processing circuit 110 performs step S730 to continue trying to free device resource(s); otherwise (i.e., all of the device resource(s) that should be freed have been freed, that is, the total number of device resource(s) ResCount in the piece of current application resource information is zero), the processing circuit 110 performs step S770.

Step S770: The processing circuit 110 removes the node corresponding to the piece of current application resource information from the process resource management list LST_AP.

Step S780: The free device resource function 436 ends normally (the first return value (e.g., 0) is returned).

In some embodiments, the process resource management list LST_AP, the device resource management list LST_DD, and the device resource information list LST_RC are embodied by Hash lists to save search time.

To sum up, because each piece of device resource information records the device resource usage count RefCnt and the application ID Pid, the usage record(s) of device resource(s) are kept in each application, and the device driver knows which device resource(s) is(are) created by the current application. In this way, when an application exits abnormally, the operating system of the electronic device 100 can normally recover or free the device resource(s) used by the device driver(s) associated with that application. Furthermore, because the piece of device resource information records the level ePL, and the device resources are freed sequentially according to the level ePL (e.g., from high to low), freeing the device resource(s) of an application does not affect the execution of other applications. That is to say, the present invention effectively manages device resources in the electronic device by creating the process resource management list LST_AP and the device resource management list LST_DD, so the electronic device of the present invention can make good use of the memory and maintain system performance.

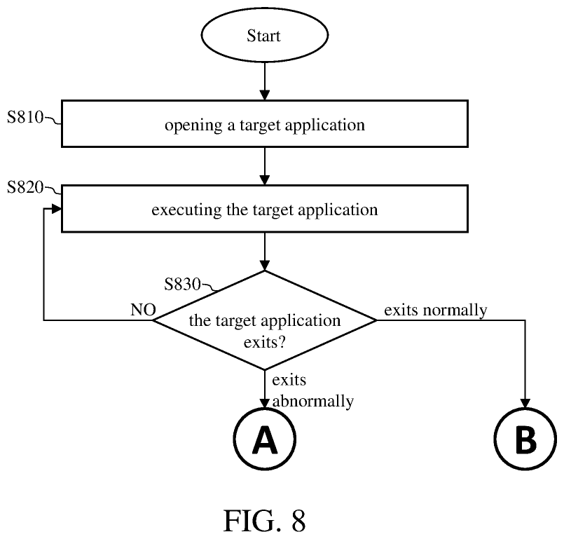

Reference is made to FIG. 8 which is a flowchart of a device resource management method according to an embodiment of the present invention. The device resource management method can be implemented in the electronic device 100 and includes the following steps.

Step S810: The processing circuit 110 opens a target application (for example, the application 122 of the OSD video superposition circuit 114 wherein the application 122 corresponds, for example, to the piece of application resource information AP1 in FIG. 2).

Step S820: The processing circuit 110 executes the target application.

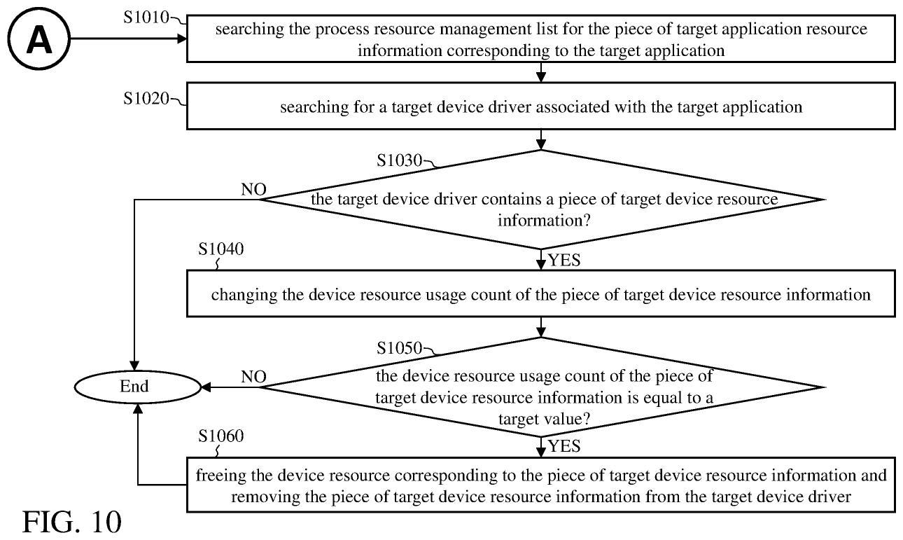

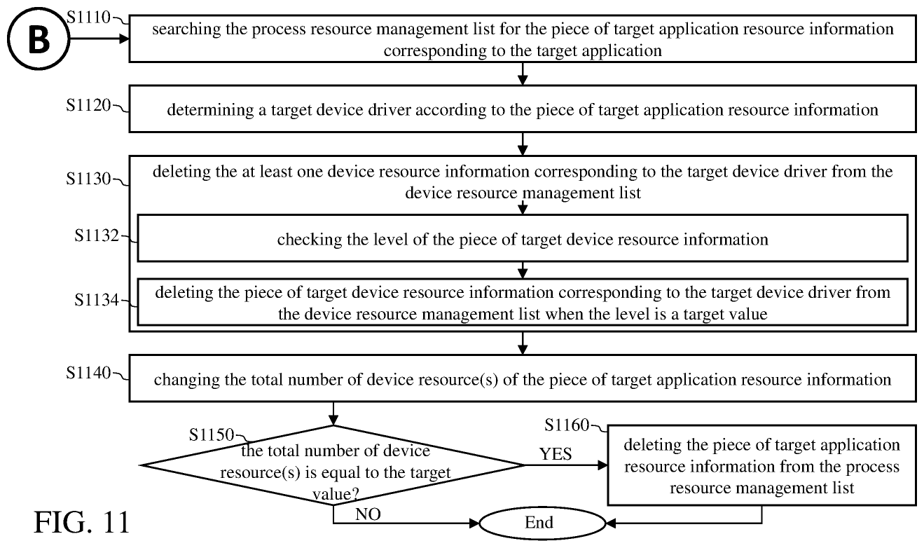

Step S830: The processing circuit 110 determines whether the target application exits. If the target application does not exit (i.e., the result of step S830 is NO), the processing circuit 110 continues to execute the target application (return to step S820). If the target application exits normally, the processing circuit 110 executes a normal exit procedure of the application (FIG. 10). If the target application exits abnormally, the processing circuit 110 executes an abnormal exit procedure of the application (FIG. 11).

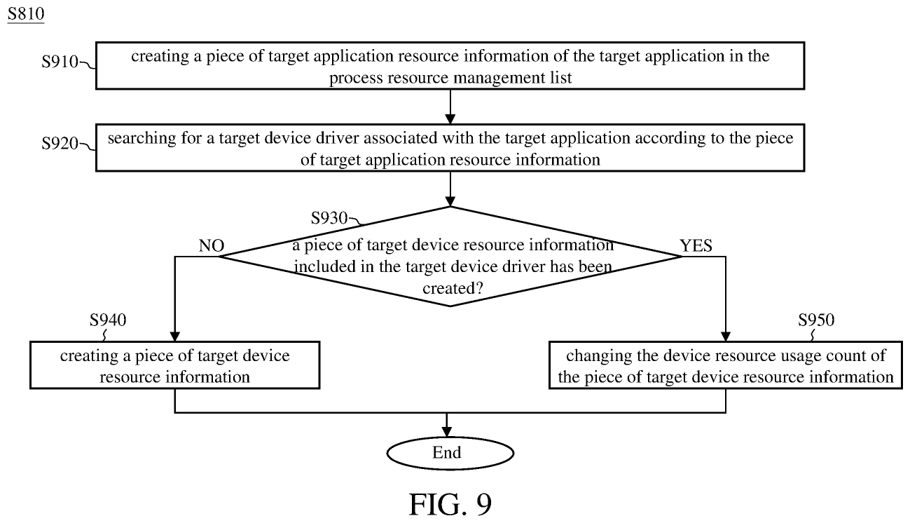

Reference is made to FIG. 9 which is a detailed process of opening an application (i.e., step S810 in FIG. 8) according to the present invention. The process includes the following steps.

Step S910: The processing circuit 110 creates a piece of target application resource information of the target application in the process resource management list LST_AP. For the implementation details of this step, please refer to the description of step S520 in FIG. 5. Continuing the example of FIG. 8, the piece of target application resource information created by the processing circuit 110 in this step is the piece of application resource information AP1.

Step S920: The processing circuit 110 searches for a target device driver associated with the target application according to the piece of target application resource information. For example, the electronic device 100 searches for the target device driver according to the device driver resource list Reslist[ ] of the piece of process resource information PRI of the piece of application resource information AP1. Note that the target application may be associated with several device drivers (for example, the device driver resource list Reslist[ ] of the piece of application resource information AP1 in FIG. 2 may point to the device driver DD1 and the device driver DD2), and the target device driver is one of the associated device drivers (for example, the target device driver is the device driver DD1).

Step S930: The processing circuit 110 determines whether a piece of target device resource information included in the target device driver has been created. For the implementation details of this step, please refer to the description of step S530 in FIG. 5. Note that the target device driver may contain multiple pieces of device resource information, and the piece of target device resource information is one of those pieces of device resource information. If NO, then the flow proceeds to step S940; otherwise, the flow proceeds to step S950.

Step S940: The processing circuit 110 creates a piece of target device resource information. For the implementation details of this step, please refer to the description of step S540 in FIG. 5. Continuing the above example, as shown in FIG. 2, the piece of target device resource information may be the piece of device resource information RC1 of the device driver DD1.

Step S950: The processing circuit 110 changes the device resource usage count RefCnt of the piece of target device resource information. For the implementation details of this step, please refer to the description of step S550 in FIG. 5.

Reference is made to FIG. 10 which is a flowchart of the normal exit procedure of an application according to an embodiment of the present invention. The normal exit procedure includes the following steps.

Step S1010: The processing circuit 110 searches the process resource management list LST_AP for the piece of target application resource information corresponding to the target application. This step is equivalent to the result of step S610 in FIG. 6 being YES. Continuing the example of FIG. 8, the piece of target application resource information found by the processing circuit 110 in this step is the piece of application resource information AP1.

Step S1020: The processing circuit 110 searches for a target device driver associated with the target application. For the implementation details of this step, please refer to the description of step S920 in FIG. 9.

Step S1030: The processing circuit 110 determines whether the target device driver contains a piece of target device resource information. For the implementation details of this step, please refer to the description of step S530 in FIG. 5. If YES, the flow proceeds to step S1040; otherwise, the normal exit procedure of the target application ends.

Step S1040: The processing circuit 110 changes the device resource usage count RefCnt of the piece of target device resource information. For the implementation details of this step, please refer to the description of step S640 in FIG. 6.

Step S1050: The processing circuit 110 determines whether the device resource usage count RefCnt of the piece of target device resource information is equal to a target value. If YES, the processing circuit 110 performs step S1060; otherwise, the normal exit procedure of the target application ends. For the implementation details of step S1050, please refer to the description of step S650 in FIG. 6.

Step S1060: The processing circuit 110 frees the device resource corresponding to the piece of target device resource information, and removes the piece of target device resource information from the target device driver. For the implementation details of this step, please refer to the description of step S660 in FIG. 6.

Reference is made to FIG. 11 which is a flowchart of the abnormal exit procedure of an application according to an embodiment of the present invention. The abnormal exit procedure includes the following steps.

Step S1110: The processing circuit 110 searches the process resource management list LST_AP for the piece of target application resource information corresponding to the target application. This step is equivalent to the result of step S710 in FIG. 7 being YES. Continuing the example of FIG. 8, the piece of target application resource information found by the processing circuit 110 in this step may be the piece of application resource information AP1.

Step S1120: The processing circuit 110 determines a target device driver according to the piece of target application resource information. More specifically, the processing circuit 110 determines the target device driver according to the device driver resource list Reslist[ ] of the piece of target application resource information. Continuing the example in FIG. 8 and FIG. 9, the target device driver determined by the processing circuit 110 in this step may be the device driver DD1.

Step S1130: The processing circuit 110 deletes a piece of target device resource information corresponding to the target device driver from the device resource management list LST_DD. Step S1130 includes sub-step S1132 and sub-step S1134. Continuing the example of FIG. 8 and FIG. 9, the processing circuit 110 may delete the piece of device resource information RC1 in this step.

Step S1132: The processing circuit 110 checks the level ePL of the piece of target device resource information. Continuing the above example, the processing circuit 110 checks the level ePL of the piece of device resource information RC1 in this step.

Step S1134: The processing circuit 110 deletes the piece of target device resource information corresponding to the target device driver from the device resource management list LST_DD when the level is a target value (e.g., 0). For the implementation details of sub-step S1132 and sub-step S1134, please refer to the description of step S730 in FIG. 7.

Step S1140: The processing circuit 110 changes the total number of device resource(s) ResCount of the piece of target application resource information, for example, decreases the total number of device resource(s) ResCount by one. For the implementation details of this step, please refer to the description of step S740 in FIG. 7. Continuing the above example, in this step, the processing circuit 110 may decrease the total number of device resource(s) ResCount in the piece of application resource information AP1 by one.

Step S1150: The processing circuit 110 determines whether the total number of device resource(s) ResCount is equal to the target value. If YES, the processing circuit 110 performs step S1160; otherwise, the abnormal exit procedure of the target application ends. For the implementation details of step S1150, please refer to the description of step S760 in FIG. 7.

Step S1160: The processing circuit 110 deletes the piece of target application resource information from the process resource management list LST_AP. For the implementation details of this step, please refer to the description of step S770 in FIG. 7. Continuing the above example, in this step, the processing circuit 110 may delete the node corresponding to the piece of application resource information AP1 from the process resource management list LST_AP.

The image-associated application circuits are intended to illustrate the invention by way of example and not to limit the scope of the claimed invention. People having ordinary skill in the art may apply the present invention to other types of application circuits and electronic devices in accordance with the foregoing discussions.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A device resource management method of an electronic device, wherein the electronic device comprises a memory and executes a plurality of applications, the memory stores a first list and a second list, the first list comprises at least one piece of application resource information, the second list comprises at least one device driver, the at least one piece of application resource information corresponds to the at least one device driver, each device driver corresponds to at least one piece of device resource information, the device resource management method comprising:
searching the first list for a piece of target application resource information corresponding to a target application of the applications in response to an abnormal exit procedure of the target application, wherein the piece of target application resource information is one of the at least one piece of application resource information;
determining a target device driver according to the piece of target application resource information; and
deleting a piece of target device resource information corresponding to the target device driver from the second list.

2. The device resource management method of claim 1, wherein the at least one piece of device resource information comprises a level, the step of deleting the piece of target device resource information corresponding to the target device driver from the second list comprising:
checking the level of the piece of target device resource information;
deleting the piece of target device resource information from the second list when the level is a target value.

3. The device resource management method of claim 1, wherein the piece of target application resource information comprises a total number of device resource(s), the device resource management method further comprising:
changing the total number of device resource(s) after deleting the piece of target device resource information corresponding to the target device driver from the second list; and
deleting the piece of target application resource information from the first list when the total number of device resource(s) is equal to a target value.

4. The device resource management method of claim 1, wherein the at least one piece of device resource information comprises a device resource usage count, the device resource management method further comprising:
creating the piece of target application resource information of the target application in the first list before the abnormal exit procedure of the target application; and
changing the device resource usage count when the target device driver comprises the piece of target device resource information.

5. The device resource management method of claim 1 further comprising:
creating the piece of target application resource information of the target application in the first list before the abnormal exit procedure of the target application; and
creating the piece of target device resource information when the target device driver does not comprises the piece of target device resource information.

6. The device resource management method of claim 1, wherein the piece of target device resource information comprises a device resource usage count, the device resource management method further comprising:
determining the piece of target device resource information from the target device driver in response to a normal exit procedure of the target application; and
changing the device resource usage count.

7. The device resource management method of claim 6 further comprising:
freeing a device resource corresponding to the at least one piece of device resource information and removing the at least one piece of device resource information from the at least one device driver when the device resource usage count is equal to a target value.

8. An electronic device executing a plurality of applications, comprising:
a memory configured to store a first list and a second list, wherein the first list comprises at least one piece of application resource information, the second list comprises at least one device driver, the at least one piece of application resource information corresponds to the at least one device driver, each device driver corresponds to at least one piece of device resource information;
an application circuit; and
a processing circuit coupled to the memory and the application circuit and configured to perform following steps:
executing a target application corresponding to the application circuit, wherein the target application is one of the applications;
searching the first list for a piece of target application resource information corresponding to the target application in response to an abnormal exit procedure of the target application, wherein the piece of target application resource information is one of the at least one piece of application resource information;
determining a target device driver according to the piece of target application resource information; and
deleting a piece of target device resource information corresponding to the target device driver from the second list.

9. The electronic device of claim 8, wherein the at least one piece of device resource information comprises a level, the step of deleting the piece of target device resource information corresponding to the target device driver from the second list comprising:
checking the level of the piece of target device resource information;
deleting the piece of target device resource information corresponding to the target device driver from the second list when the level is a target value.

10. The electronic device of claim 8, wherein the piece of target application resource information comprises a total number of device resource(s), the processing circuit further performing following steps:
changing the total number of device resource(s) after deleting the piece of target device resource information corresponding to the target device driver from the second list; and
deleting the piece of target application resource information from the first list when the total number of device resource(s) is equal to a target value.

11. An electronic device executing a plurality of applications, comprising:
a memory configured to store a first list and a second list, wherein the first list comprises at least one piece of application resource information, the second list comprises at least one device driver, the at least one piece of application resource information corresponds to the at least one device driver, each device driver corresponds to at least one piece of device resource information;
an application circuit; and
a processing circuit coupled to the memory and the application circuit and configured to perform following steps:
executing a target application corresponding to the application circuit, wherein the target application is one of the applications;
creating a piece of target application resource information of the target application in the first list;
searching for a target device driver associated with the target application according to the piece of target application resource information; and
creating a piece of target device resource information when the target device driver does not comprise the piece of target device resource information;
wherein the piece of target device resource information corresponds to the target device driver and is recorded in a device resource information list used by the target device driver.

12. The electronic device of claim 11, wherein the at least one piece of device resource information comprises a device resource usage count, the processing circuit further performing following steps:
changing the device resource usage count when the target device driver comprises the piece of target device resource information.

13. The electronic device of claim 11, wherein the piece of target device resource information comprises a device resource usage count, the processing circuit further performing following steps:
searching the target device driver for the piece of target device resource information in response to a normal exit procedure of the target application; and
changing the device resource usage count.

14. The electronic device of claim 13, wherein the processing circuit further performs following steps:
freeing a device resource corresponding to the at least one piece of device resource information and removing the at least one piece of device resource information from the at least one device driver when the device resource usage count is equal to a target value.

15. The electronic device of claim 13, wherein the processing circuit further performs following steps:
searching the first list for the piece of target application resource information corresponding to the target application in response to an abnormal exit procedure of the target application;
determining the target device driver according to the piece of target application resource information; and
deleting the piece of target device resource information from the second list.
